(19) United States
(12) Patent Application Publication
(10) Pub. No.: US 2012/0280572 A1
(43) Pub. Date: Nov. 8, 2012

(54) BATTERY SYSTEMS AND CONTROLLERS

(75) Inventors: Guoxing Li, Sunnyvale, CA (US); Han-Jung Kao, Taipei (TW)

(73) Assignee: O2Micro, Inc., Santa Clara, CA (US)

(21) Appl. No.: 13/445,371

(22) Filed: Apr. 12, 2012

Related U.S. Application Data
(60) Provisional application No. 61/482,944, filed on May 5, 2011.

(51) Int. Cl. H02J 1/00

(52) U.S. Cl. 307/77

(57) ABSTRACT

A battery system includes battery cells and a control circuit having a control pin. The control circuit determines a condition of the battery cells according to cell parameters of the battery cells. The control circuit compares a voltage at the control pin with a first voltage threshold to select an operation mode from a first mode and a second mode. In the first mode, the control circuit compares the voltage at the control pin with a second voltage threshold and generates a control signal based on a result of the comparison, such that the control signal is generated if the battery cells remain in the condition for a time period that reaches a first time threshold. In the second mode, the control circuit generates the control signal if the battery cells remain in the condition for a time period that reaches a second time threshold.

### RELATED APPLICATION

This application claims priority to U.S. Provisional Application No. 61/482,944, filed on May 5, 2011, which is hereby incorporated by reference in its entirety.

### BACKGROUND

Rechargeable multi-cell battery packs are widely used in electronic devices such as cellular phones and laptop computers. A charger is used to connect the battery pack to a power outlet to charge the battery pack. The rechargeable battery pack usually includes a primary protection circuit for protecting the battery pack against an over-voltage condition. For example, if a cell voltage of a battery cell is greater than a predetermined threshold V_{TH1} during a charging process, the primary protection circuit terminates the charging operation by switching off a charging switch coupled between the battery pack and the charger. Some battery packs may further include a secondary protection circuit as a backup for the primary protection circuit.

FIG. 1 illustrates a block diagram of a conventional battery system 100 including a secondary protection circuit 101. The secondary protection circuit 101 includes comparators 106_1-106_4 and 114, an OR gate 108, switches 110, 112 and 120, a pair of current generators 116 and 118, and a mode selection circuit 104. The comparators 106_1, 106_2, 106_3 and 106_4 detect cell voltages of multiple battery cells 102_1, 102_2, 102_3 and 102_4 via the pins VC1-VC4 and the pin GND, and respectively compare the cell voltages with a threshold V_{TH2} that is greater than the threshold V_{TH1}. If each of the cell voltages is less than the threshold V_{TH2}, the comparators reset the OR gate 108 to turn on the switch 110 and turn off the switch 112. Thus, the capacitor C_{DELAY} is discharged to decrease the voltage V_{C} across the capacitor C_{DELAY} coupled to a pin CD. If any of the cell voltages is greater than the threshold V_{TH2}, which indicates that a battery cell is experiencing an over-voltage condition, a corresponding comparator sets the OR gate 108 to turn on the switch 112 and turn off the switch 110. Thus, a current I_{C} is generated to charge the capacitor C_{DELAY}, and the voltage V_{C} increases accordingly. When the voltage V_{C} rises to the voltage threshold V_{TH3}, the comparator 114 turns on the switch 122. As such, a current I_{FUSE} is generated to burn out the fuse 124 coupled between the battery cells 102_1-102_4 and a charger.

Accordingly, the secondary protection circuit 101 monitors the cell voltage in case the primary protection circuit fails to terminate the charging operation in response to an over-voltage condition (e.g., a cell voltage exceeds the threshold V_{TH1}). If the over-voltage condition becomes worse (e.g., the cell voltage stays above the threshold V_{TH2} for a time period longer than a time threshold T_{TH}), the secondary protection circuit burns out the fuse 124. As a result, the charging operation is terminated and the battery cells are prevented from being damaged.

The mode selection circuit 104 compares a difference V_{DIFF} between voltages at the pins VDD and VC1, e.g., V_{DIFF}=V_{VDD}−V_{VC1}, with a voltage threshold V_{TH4} to switch the circuit 101 between a normal mode and a test mode. In FIG. 1, the difference V_{DIFF} is less than the voltage threshold V_{TH4}. As such, the mode selection circuit 104 operates in the normal mode to turn off the switch 120. Since the current I_{C} for charging the capacitor C_{DELAY} is equal to the current I1 generated by the current generator 118, the time threshold T_{TH} is equal to (C_{DELAY}*V_{TH3})/I1.

FIG. 2 illustrates a block diagram of a conventional testing system 200 in which the secondary protection circuit 101 is under test. Elements labeled the same as in FIG. 1 have similar functions. The testing system 200 includes a signal generator 202 for generating test signals at the pins VC1-VC4, GND and VDD, and further includes a signal analyzer 204 for identifying whether the circuit 101 is operating properly based on the output signal at the pin OUT. In operation, the signal generator 202 enables the voltage at the pin VDD to be greater than the voltage at the pin VC1 plus the threshold V_{TH4}. As such, the mode selection circuit 104 turns on the switch 120 to switch the circuit 101 to the test mode. In this condition, the current I_{C}′ is equal to the sum of the current I1 generated by the current generator 118 and the current I2 generated by the current generator 116. As such, the time threshold T_{TH}′ is equal to (C_{DELAY}*V_{TH3})/(I1+I2), which is less than the time threshold T_{TH} in the normal operation mode. Since T_{TH}′ is less than T_{TH}, the total time for testing the circuit 101 is shortened.

However, as the voltage V_{VC1} at the pin VC1 is approximately equal to the total voltage of the battery cells 102_1-102_4, it is a challenge for the signal generator 202 to generate the voltage V_{VDD} greater than the voltage V_{VC1} plus the threshold V_{TH4}. In some circumstances, the circuit 101 is tested when the peripheral components (in FIG. 1) are connected to the circuit 101. Thus, the relatively high level voltage at the pin VDD may damage the capacitor C_{VD} or shorten the life time of the capacitor C_{VD}.

Moreover, when the charger is coupled to the power outlet or a load is coupled to the battery cells 102_1-102_4 during a normal charging operation of the circuit 101, the voltage V_{VDD} may have transient pulses or spikes. In other words, the voltage V_{VDD} may be greater than the voltage V_{VC1} plus the threshold V_{TH4} during a relatively short time period. As such, even if the circuit 101 is in the normal operation rather than in the test mode, the mode selection circuit 104 is mistakenly switched to the test mode that results in shortening the time threshold from T_{TH} to T_{TH}′. Therefore, the accuracy of the secondary protection circuit 101 is decreased.

### SUMMARY

In one embodiment, a battery system includes battery cells and a control circuit having a control pin. The control circuit determines a condition of the battery cells according to cell parameters of the battery cells. The control circuit compares a voltage at the control pin with a first voltage threshold to select an operation mode from a first mode and a second mode. In the first mode, the control circuit compares the voltage at the control pin with a second voltage threshold and generates a control signal based on a result of the comparison, such that the control signal is generated if the battery cells remain in the condition for a time period that reaches a first time threshold. In the second mode, the control circuit generates the control signal if the battery cells remain in the condition for a time period that reaches a second time threshold.

### BRIEF DESCRIPTION OF THE DRAWINGS

Features and advantages of embodiments of the subject matter will become apparent as the following detailed description proceeds, and upon reference to the drawings, wherein like numerals depict like parts, and in which:

FIG. 1 illustrates a block diagram of a conventional battery system in which a secondary protection circuit operates in a normal operation.

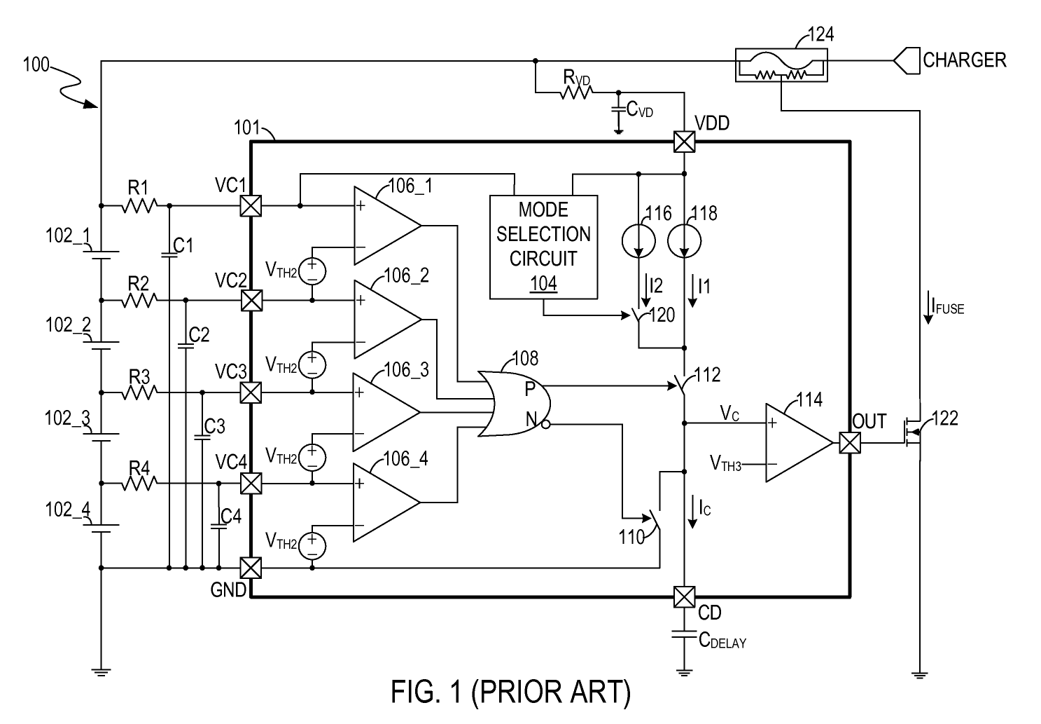

FIG. 2 illustrates a block diagram of a conventional testing system in which the secondary protection circuit is under test.

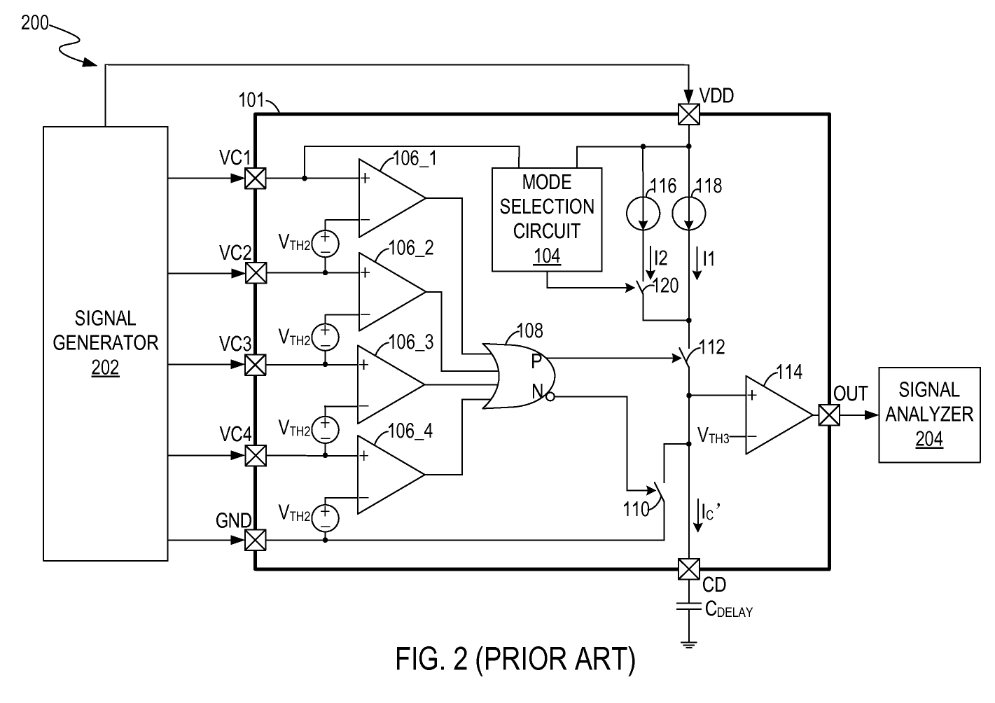

FIG. 3 illustrates a block diagram of a battery system, in accordance with one embodiment of the present invention.

FIG. 4 illustrates an example of a control circuit, in accordance with one embodiment of the present invention.

FIG. 5 illustrates another example of a control circuit, in accordance with one embodiment of the present invention.

FIG. 6 illustrates a block diagram of a test system in which a control circuit is under test, in accordance with one embodiment of the present invention.

FIG. 7 illustrates a flowchart of operations performed by a testing system, in accordance with one embodiment of the present invention.

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

Embodiments in accordance with the present disclosure provide a battery system. The battery system includes a plurality of battery cells having a plurality of cell parameters and further includes a control circuit having a control pin. The control circuit determines a condition of the battery cells according to the cell parameters. Advantageously, the control circuit compares a voltage at the control pin with a first voltage threshold to select an operation mode from a first mode and a second mode. In the first mode, the control circuit compares the voltage at the control pin with a second voltage threshold and generates a control signal based on a result of the comparison, such that the control signal is generated if the battery cells remain in the condition for a time period that reaches a first time threshold. In the second mode, the control circuit generates the control signal if the battery cells remain in the condition for a time period that reaches a second time threshold. The control signal can be used to perform a protective action. Advantageously, since the mode selection is based on the voltage at the control pin instead of a power pin for receiving an input power, the mode selection is not affected by undesirable conditions or noise at the power pin. For example, during a charging operation, the control circuit remains in the normal mode even if the voltage at the power pin has transient pulses. As such, the accuracy of the control circuit is enhanced.

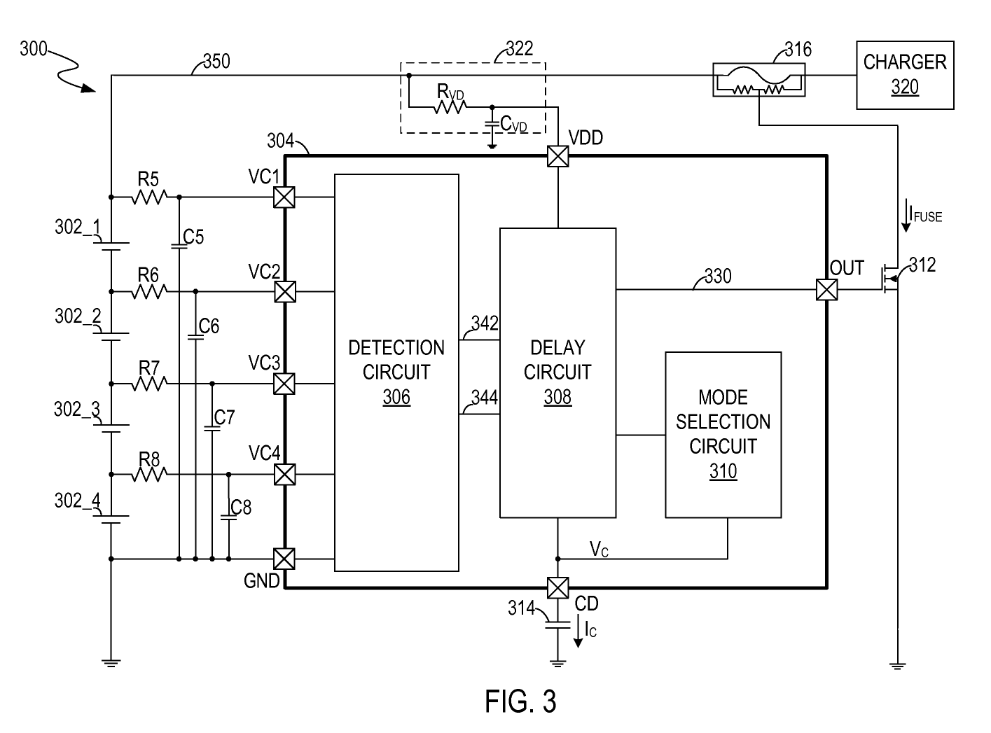

FIG. 3 illustrates a block diagram of a battery system 300, in accordance with one embodiment of the present invention. The battery system 300 includes battery cells 302_1-302_4, a control circuit 304, a switch 312, a capacitor 314, a fuse 316, and a charger 320. During a charging process, the charger 320 is connected to a power outlet and provides output power at a power line 350 to charge the series-connected battery cells 302_1-302_4. The control circuit 304 includes multiple pins such as pins VC1-VC4, a pin GND, a pin CD, a pin VDD and a pin OUT. The control circuit 304 detects cell parameters of the battery cells 302_1-302_4 through the pins VC1-VC4 and determines whether the battery cells 302_1-302_4 are in a normal condition or an abnormal condition accordingly. The abnormal condition of the battery cells 302_1-302_4 can be, but is not limited to, an over-voltage condition, an under-voltage condition, or an over-temperature condition. In one embodiment, the control circuit 304 generates a control signal 330 indicating that the battery cells 302_1-302_4 are in an abnormal condition if the battery cells 302_1-302_4 are in the abnormal condition for a period of time equal to or greater than a time threshold T_{TH}. In other words, if an abnormal condition of the battery cells 302_1-302_4 is identified, the control circuit 304 sets a delay time, e.g., equal to T_{TH}. The control signal 330 is generated if the battery cells remain in the abnormal condition after the delay time expires. The control signal 330 turns on a switch 312 coupled to the pin OUT, thereby enabling a current I_{FUSE} through the fuse 316 coupled between the charger 320 and the battery cells 302_1-302_4. The fuse 316 is burned out to terminate the charging operation.

The battery cells 302_1-302_4 can be, but are not limited to, Lilon/Polymer cells, Lead-Acid cells, NiCD/NiMH cells or super capacitors. Four battery cells are shown in the example of FIG. 3 for illustrative purposes. Other numbers of battery cells can be included in the battery system 300. Each battery cell 302_1-302_4 has a cell parameter that is monitored. The cell parameter can be, but is not limited to, a state of charge (SOC) of the battery cell, a cell voltage of the battery cell, or a capacity of the battery cell. In the following descriptions, the cell parameter refers to the cell voltage and the abnormal condition of the battery cells refers to the over-voltage condition for illustrative purposes; however, other parameter and other condition can also be used as the cell parameter and the abnormal condition in this invention.

In the example of FIG. 3, the control circuit 304 includes a detection circuit 306, a delay circuit 308, and a mode selection circuit 310. The pins VC1-VC4 of the control circuit 304 are coupled to the battery cells 302_1-302_4 through multiple R-C filters. For example, the pin VC1 is coupled to a positive terminal of the battery cell 302_1 via an R-C filter including a resistor R5 and a capacitor C5; the pin VC2 is coupled to a positive terminal of the battery cell 302_2 via an R-C filter including a resistor R6 and a capacitor C6; the pin VC3 is coupled to a positive terminal of the battery cell 302_3 via an R-C filter including a resistor R7 and a capacitor C7; and the pin VC4 is coupled to a positive terminal of the battery cell 302_4 via an R-C filter including a resistor R8 and a capacitor C8.

In one embodiment, the detection circuit 306 receives signals at the pins VC1-VC4 to obtain the cell voltages of battery cells 302_1-302_4. Accordingly, the detection circuit 306 determines whether a battery cell is undergoing an over-voltage condition. If an over-voltage condition is identified, the detection circuit 306 generates switch control signals 342 and 344. The delay circuit 308 is coupled to the power line 350 via an R-C filter 322 to receive power from the power line 350. The delay circuit 308 provides the time threshold T_{TH} upon receiving the switch control signals 342 and 344.

The control circuit 304 is capable of operating in a normal mode and a test mode to determine the time threshold T_{TH}. In one embodiment, the mode selection circuit 310 coupled to the pin CD detects a voltage V_{C} at the pin CD and switches the control circuit 304 between the normal mode and the test mode accordingly. In the normal mode, the switch control signals 342 and 344 control the delay circuit 308 to generate a current I_{C} flowing through the capacitor 314 that is coupled to the delay circuit 308 via the pin CD. In one embodiment, the current I_{C} charges the capacitor 314, such that a voltage V_{C} across the capacitor 314 is increased. Based on the voltage V_{C}, the delay circuit 308 determines the time threshold T_{TH} in the normal mode (referred as T_{TH}_{_{—}}_{NORMAL}). In the test mode, the switch control signals 342 and 344 control the delay circuit 308 to provide the time threshold T_{TH} (referred as T_{TH}_{_{—}}_{TEST}) that is different from the time threshold T_{TH}_{_{—}}_{NORMAL} in the normal mode. In one embodiment, T_{TH}_{_{—}}_{TEST} is less than T_{TH}_{_{—}}_{NORMAL}.

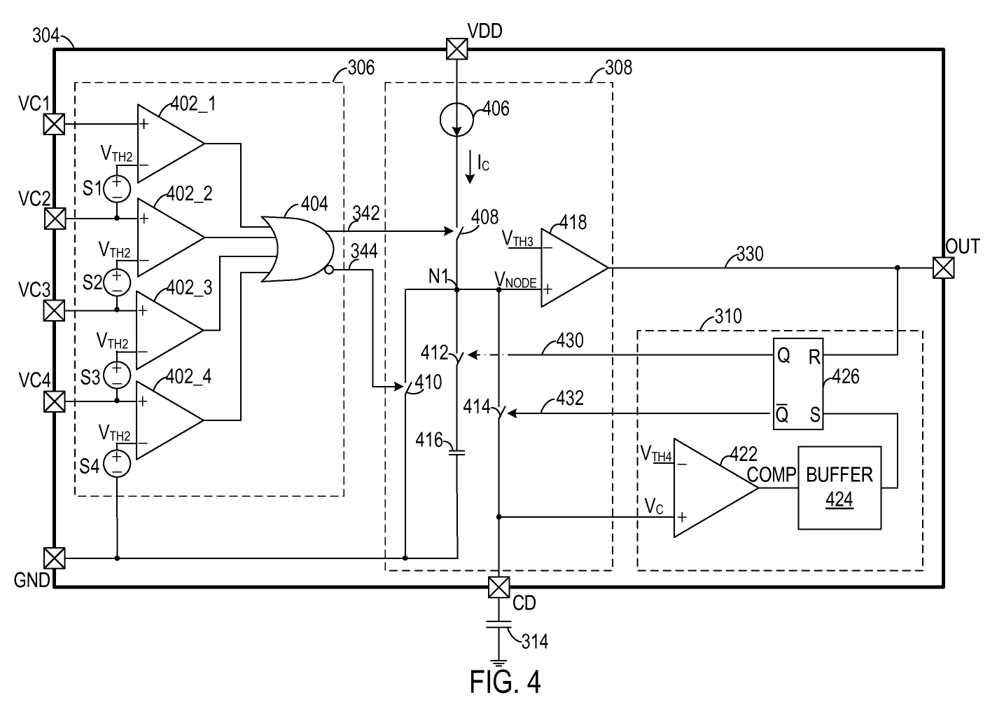

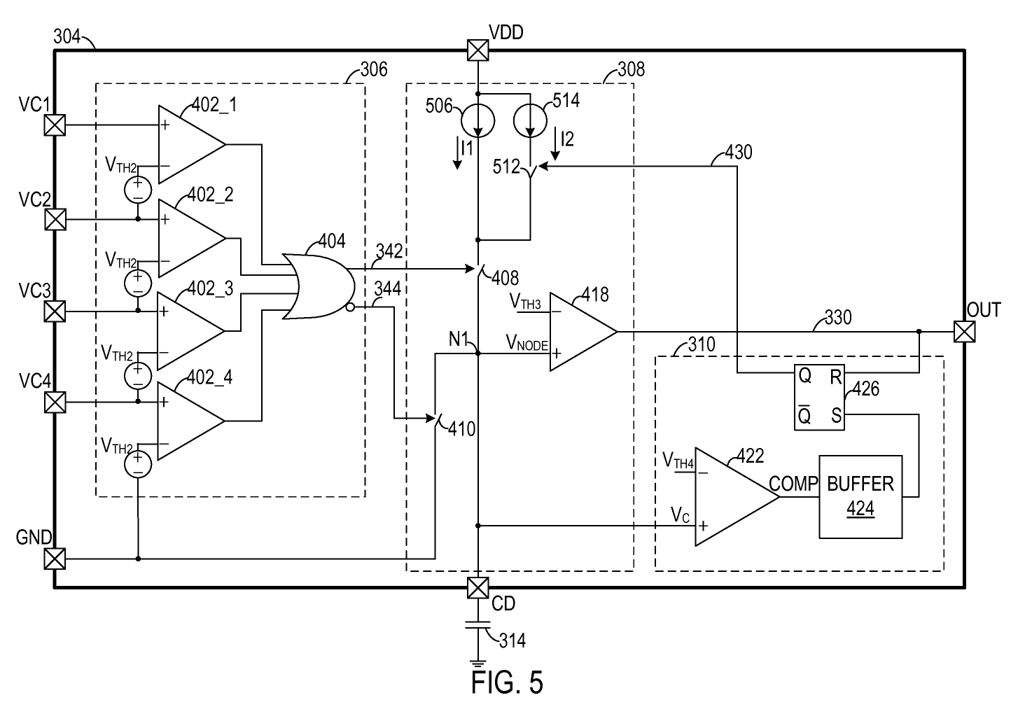

Therefore, in the normal mode, the delay circuit 308 generates the control signal 330 if the battery cells remain in the over-voltage condition for a period of time equal to or greater than the time threshold T_{TH}_{_{—}}_{NORMAL}. In the test mode, the delay circuit 308 generates the control signal 330 if the battery cells remain in the over-voltage condition for a period of time equal to or greater than the time threshold T_{TH}_{_{—}}_{TEST}. The operation of the control circuit 304 is further described in relation to FIG. 4 and FIG. 5.

Advantageously, the control circuit 304 is switched between the normal mode and the test mode according to the voltage at the pin CD instead of the pin VDD. Therefore, the mode selection is not affected by undesirable conditions or noise at the pin VDD. For example, during a charging operation, e.g., as shown in FIG. 3, the control circuit 304 remains in the normal mode even if the voltage at the pin VDD has transient pulses. As such, the accuracy of the control circuit 304 is improved.

FIG. 4 illustrates an example of the control circuit 304, in accordance with one embodiment of the present invention. Elements labeled the same as in FIG. 3 have similar functions. FIG. 4 is described in combination with FIG. 3.

In the example of FIG. 4, the detection circuit 306 includes comparators 402_1-402_4 and an OR gate 404. The comparators 402_1-402_4 have multiple input terminals coupled to the pins VC1-VC4 and the pin GND. More specifically, the comparator 402_1 has a non-inverting input terminal coupled to the pin VC1 and has an inverting input terminal coupled to the pin VC2 via a voltage source S1; the comparator 402_2 has a non-inverting input terminal coupled to the pin VC2 and has an inverting input terminal coupled to the pin VC3 via a voltage source S2; the comparator 402_3 has a non-inverting input terminal coupled to the pin VC3 and has an inverting input terminal coupled to the pin VC4 via a voltage source S3; and the comparator 402_4 has a non-inverting input terminal coupled to the pin VC4 and has an inverting input terminal coupled to the pin GND via a voltage source S4.

Each of the voltage sources S1-S4 generates a voltage threshold V_{TH2}. As such, each comparator 402_1-402_4 compares the cell voltage of a corresponding battery cell with the voltage threshold V_{TH2} to generate an output signal at a corresponding output terminal. The OR gate 404 has input terminals respectively coupled to the output terminals of the comparators 402_1-402_4, and has a non-inverting output terminal and an inverting output terminal for generating the switch control signals 342 and 344, respectively. More specifically, in one embodiment, if every cell voltage is less than the voltage threshold V_{TH2} (indicating that the battery cells are in a normal condition), the switch control signals 342 and 344 are logic low and logic high, respectively. If one or more of the cell voltages are greater than the voltage threshold V_{TH2} (indicating that the battery cells are in an over-voltage condition), the switch control signals 342 and 344 are logic high and logic low, respectively.

In one embodiment, the delay circuit 308 includes a current source 406, a capacitor 416, a comparator 418 and switches 408, 410, 412 and 414. The switch control signals 342 and 344 are used to control the switches 408 and 410, respectively. In one embodiment, if the switch control signals 342 and 344 are logic low and logic high indicating that the battery cells are in the normal condition, then the switch 408 is turned off and the switch 410 is turned on. If the switch control signals 342 and 344 are logic high and logic low indicating that the battery cells are in the over-voltage condition, then the switch 408 is turned on and the switch 410 is turned off.

The current source 406 coupled to the node N1 via the switch 408 generates a current I_{C}. The series-connected switch 412 and the capacitor 416 are coupled between the node N1 and the pin GND. The switch 410 is coupled between the node N1 and the pin GND. The switch 414 is coupled between the node N1 and the pin CD. The comparator 418 compares the voltage V_{NODE} at the node N1 with the voltage threshold V_{TH3} to generate the control signal 330.

In one embodiment, the mode selection circuit 310 includes a comparator 422, a buffer 424, and an S-R flip flop 426. The comparator 422 has a non-inverting input terminal coupled to the pin CD. The comparator 422 compares the voltage V_{C} at the pin CD to a voltage threshold V_{TH4} and generates a comparing signal COMP according to a result of the comparison. In one embodiment, the voltage threshold V_{TH4} is greater than the voltage threshold V_{TH3} and is less than a sum of the cell voltages of the battery cells 302_1-302_4. The buffer 424 buffers the comparing signal COMP and applies the comparing signal COMP to an input terminal S of the flip flop 426. The flip flop 426 further includes an input terminal R coupled to the pin OUT for receiving the control signal 330.

Based upon the comparing signal COMP, the flip flop 426 outputs mode selection signals 430 and 432 to switch the control circuit 304 between the normal mode and the test mode. More specifically, in one embodiment, the mode selection signals 430 and 432 are used to control the switches 412 and 414, respectively. If the voltage V_{C} is less than the voltage threshold V_{TH4}, then the mode selection signals 430 and 432 turn on the switch 414 and turn off the switch 412 to select the normal mode. Thus, when an over-voltage condition is identified (e.g., the switch 408 is turned on and the switch 410 is turned off according to the switch control signals 342 and 344), the current I_{C} is conducted to the capacitor 314 coupled to the pin CD. As such, the voltage V_{NODE} at the node N1 is increased according to the voltage V_{C} across the capacitor 314. When the voltage V_{NODE} reaches the voltage threshold V_{TH3}, the comparator 418 generates the control signal 330 (e.g., logic high) at the pin OUT. As such, the time threshold T_{TH}_{_{—}}_{NORMAL} in the normal mode can be given by equation (1):

T_{TH}_{_{—}}_{NORMAL}=C₃₁₄*V_{TH3}/I_{C}, (1)

where C₃₁₄ represents the capacitance of the capacitor 314.

If the voltage V_{C} is greater than the voltage threshold V_{TH4}, the mode selection signals 430 and 432 turn off the switch 414 and turn on the switch 412 to select the test mode. Thus, when an over-voltage condition is identified, the current I_{C} is conducted to the capacitor 416. As such, the voltage V_{NODE} is increased according to a voltage across the capacitor 416. Therefore, the time threshold T_{TH}_{_{—}}_{TEST} in the test mode is given by equation (2):

T_{TH}_{_{—}}_{TEST}=C₄₁₆*V_{TH3}/I_{C}, (2)

where C₄₁₆ represents the capacitance of the capacitor 416. In one embodiment, C₄₁₆ is set to be less than C₃₁₄. Based on equations (1) and (2), T_{TH}_{_{—}}_{TEST} is less than T_{TH}_{_{—}}_{NORMAL}. The detection circuit 306 and the mode selection circuit 310 can have other configurations, and are not limited to the example in FIG. 4.

FIG. 5 illustrates another example of the control circuit 304, in accordance with one embodiment of the present invention. Elements labeled the same as in FIG. 3 and FIG. 4 have similar functions. FIG. 5 is described in combination with FIG. 3 and FIG. 4.

In the example of FIG. 5, the delay circuit 308 includes current sources 506 and 514, switches 408, 410 and 512, and a comparator 418. The detection circuit 306 generates the switch control signals 342 and 344 to control the switches 408 and 410. The mode selection circuit 310 generates the mode selection signal 430 to control the switch 512 so as to switch the control circuit 304 between the normal mode and the test mode. More specifically, in one embodiment, if the voltage V_{C} is less than the voltage threshold V_{TH4}, the mode selection signal 430 turns off the switch 512 to select the normal mode. Thus, when an over-voltage condition is identified, the current I1 flows through the capacitor 314. As such, the time threshold T_{TH}_{_{—}}_{NORMAL} in the normal mode can be given by equation (3):

T_{TH}_{_{—}}_{NORMAL}=C₃₁₄*V_{TH3}/I1. (3)

If the voltage V_{C} is greater than the voltage threshold V_{TH4}, the mode selection signals 430 turns on the switch 512 to select the test mode. Thus, when an over-voltage condition is identified, both the current I1 and the current I2 flow through the capacitor 314. Therefore, the time threshold T_{TH}_{_{—}}_{TEST} in the test mode can be given by equation (4):

T_{TH}_{_{—}}_{TEST}=C₃₁₄*V_{TH3}/(I1+I2). (4)

As shown in equations (3) and (4), T_{TH}_{_{—}}_{TEST} is less than T_{TH}_{_{—}}_{NORMAL}. The delay circuit 308 can have other configurations and is not limited to the example in FIG. 4 and FIG. 5.

Therefore, as shown in the examples of FIG. 4 and FIG. 5, the control circuit 314 selectively operates in the normal mode or the test mode according to the voltage V_{C} at the pin CD. Referring to FIG. 3, the control circuit 304 is coupled to the battery cells 302_1-302_4 during a charging operation. Since the voltage threshold V_{TH3} is less than the voltage threshold V_{TH4}, the voltage V_{C} is less than the voltage threshold V_{TH4}. As such, during the charging operation, the control circuit 304 operates in the normal mode to provide the time threshold T_{TH}_{_{—}}_{NORMAL}. Thus, when an over-voltage condition is identified, the control circuit 304 can have enough delay time, e.g., equal to T_{TH}_{_{—}}_{NORMAL}, before generating the control signal 330. Advantageously, undesirable conditions or noise such as transient voltage pulses at the pin VDD do not affect the mode selections. Thus, the accuracy of the control circuit 304 is improved.

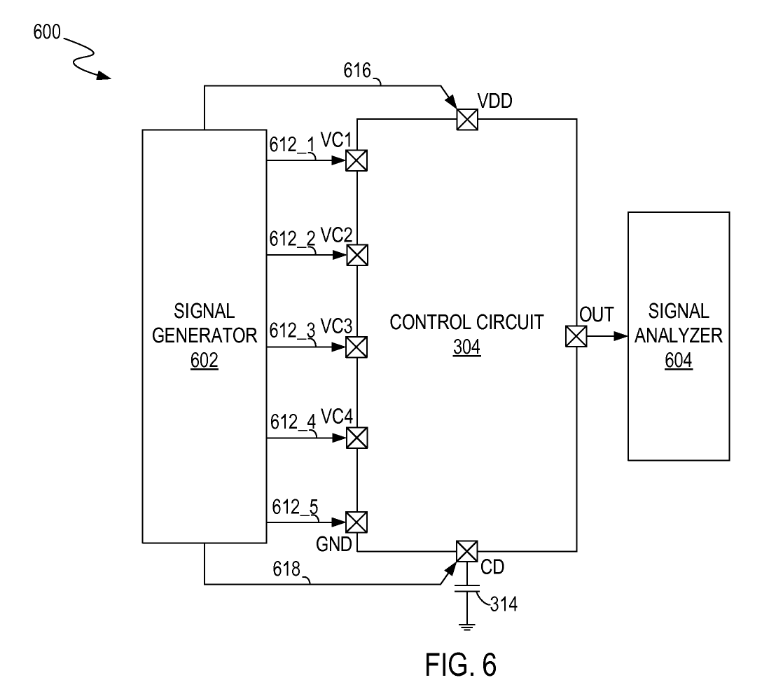

FIG. 6 illustrates a block diagram of a testing system 600 in which the control circuit 304 is under test, in accordance with one embodiment of the present invention. Elements labeled the same as in FIG. 3 have similar functions. FIG. 6 is described in combination with FIG. 3-FIG. 5. In the example of FIG. 6, the testing system 600 includes a signal generator 602 and a signal analyzer 604. The signal generator 602 applies multiple test signals 612_1-612_5 to the pins VC1-VC4 and GND to simulate the cell voltages of the battery cells 302_1-302_4. For example, the test signals 612_1-612_5 can simulate a normal condition and an over-voltage condition. The signal generator 602 further applies a driving voltage 616 to the pin VDD to drive the control circuit 304. The signal analyzer 604 receives the control signal 330 to determine whether the control circuit 304 is operating properly, e.g., whether the control signal 330 is generated if the control circuit 304 stays in the over-voltage condition for more than the time threshold T_{TH}.

Advantageously, the signal generator 602 provides a trigger voltage 618 to the pin CD during startup of the testing system. The trigger voltage 618 is greater than the voltage threshold V_{TH4}, which switches the control circuit 304 to the test mode. Thus, the time threshold T_{TH} is equal to T_{TH}_{_{—}}_{TEST}, which is less than T_{TH}_{_{—}}_{NORMAL}. As such, when an over-voltage condition is identified during the test mode, the control circuit 304 spends less delay time than that during a normal charging operation. Therefore, the total time period for testing the control circuit 304 is shortened, which decreases the testing cost for the control circuit 304.

Moreover, the voltage threshold V_{TH4} is set to be greater than V_{TH3} and less than the total voltage of the battery cells 302_1-302_4. Thus, the trigger voltage 618 at the pin CD can be less than or equal to the total voltage of the battery cells 302_1-302_4. Also, the driving voltage 616 at the pin VDD can be less than or equal to the total voltage of the battery cells 302_1-302_4. In other words, the signal generator 602 does not generate a voltage having a relatively high voltage level, e.g., greater than the total voltage of the battery cells 302_1-302_4. Thus, the peripheral components of the control circuit 304, e.g., the capacitor C_{VD}, are protected from being damaged and the lifetimes of those components are lengthened.

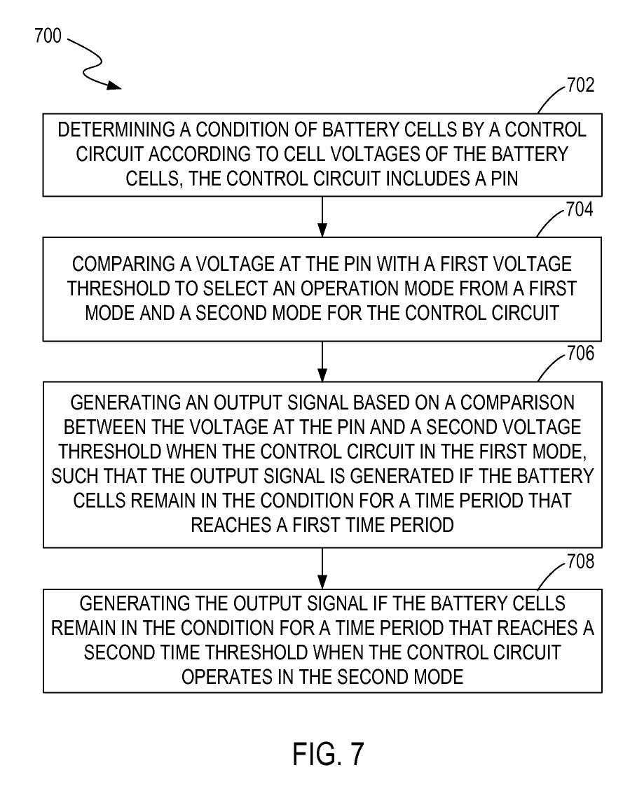

FIG. 7 illustrates a flowchart 700 of operations performed by a battery system, e.g., the battery system 300, in accordance with one embodiment of the present invention. FIG. 7 is described in combination with FIG. 3-FIG. 6. Although specific steps are disclosed in FIG. 7, such steps are examples. That is, the present invention is well suited to performing various other steps or variations of the steps recited in FIG. 7.

In block 702, a condition of battery cells is determined by a control circuit, e.g., the control circuit 304, according to cell voltages of the battery cells. The control circuit includes a control pin, e.g., the pin CD.

In block 704, a voltage at the pin is compared with a first voltage threshold, e.g., V_{TH4}, to select an operation mode from a first mode, e.g., the normal mode, and a second mode, e.g., the test mode, for the control circuit. In one embodiment, a signal generator provides a test voltage that is greater than the first voltage threshold to enable the control circuit to operate in the second mode, e.g., during testing.

In block 706, an output signal, e.g., the control signal 330, is generated based on a comparison between the voltage at the pin and a second voltage threshold, e.g., V_{TH3}, such that the output signal is generated if the battery cells remain in the condition for a time period that reaches a first time period, e.g., T_{TH}_{_{—}}_{NORMAL}. In block 708, the output signal is generated if the battery cells remain in the condition for a time period that reaches a second time threshold, e.g., T_{TH}_{_{—}}_{TEST}, when the control circuit operates in the second mode. In one embodiment, a first current is generated to flow through a capacitor coupled to the pin, e.g., the capacitor 314, when the control circuit operates in the first mode. A second current is generated to flow through the capacitor when the control circuit operates in the second mode. The second current is greater than the first current. The voltage at the pin is compared with the second voltage threshold to generate the output signal when the control circuit operates in the second mode. In one embodiment, a current is conducted through a first capacitor coupled to the pin, e.g., the capacitor 314, when the control circuit operates in the first mode. The current is conducted through a second capacitor when the control circuit operates in the second mode. The capacitance of the second capacitor is less than the capacitance of the first capacitor. A voltage at the second capacitor is compared with the second voltage threshold to generate the output signal when the control circuit operates in the second mode.

While the foregoing description and drawings represent embodiments of the present invention, it will be understood that various additions, modifications and substitutions may be made therein without departing from the spirit and scope of the principles of the present invention. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, and not limited to the foregoing description.

1. A battery pack comprising:
a plurality of battery cells having a plurality of cell parameters; and
a control circuit that has a pin, that determines a condition of said battery cells according to said cell parameters, and that compares a voltage at said pin with a first voltage threshold to select an operation mode from a first mode and a second mode,
wherein in said first mode said control circuit compares said voltage at said pin with a second voltage threshold and generates a control signal based on a result of said comparison, such that said control signal is generated if said battery cells remain in said condition for a time period that reaches a first time threshold,
wherein in said second mode said control circuit generates said control signal if said battery cells remain in said condition for a time period that reaches a second time threshold.

2. The battery pack as claimed in claim 1, wherein said cell parameters comprise a plurality of cell voltages of said battery cells respectively, and wherein said condition comprises an over-voltage condition.

3. The battery pack as claimed in claim 1, wherein said control circuit further comprises:
a delay circuit that generates a first current flowing through a capacitor coupled to said pin when said control circuit operates in said first mode and that generates a second current flowing through said capacitor when said control circuit operates in said second mode,
wherein said first time threshold is equal to a time period when a voltage of said capacitor varies from a predetermined voltage level to a level equal to said second voltage threshold in said first mode, and wherein said second time threshold is equal to a time period when said voltage of said capacitor varies from said predetermined voltage level to the level equal to said second voltage threshold in said second mode.

4. The battery pack as claimed in claim 3, wherein said delay circuit comprises:
a pair of current sources that generate a third current and a fourth current respectively, wherein the level of said first current is equal to a level of said third current, and wherein the level of said second current is equal to a sum of said third current and said fourth current.

5. The battery pack as claimed in claim 1, wherein said control circuit further comprises:
a delay circuit that conducts a current through a first capacitor coupled to said pin when said control circuit operates in said first mode and that conducts said current through a second capacitor when said control circuit operates in said second mode,
wherein said first time threshold is equal to a time period when a voltage of said first capacitor varies from a predetermined voltage level to a level equal to said second voltage threshold, and wherein said second time threshold is equal to a time period when a voltage of said second capacitor varies from said predetermined voltage level to the level equal to said second voltage threshold.

6. The battery pack as claimed in claim 5, wherein the capacitance of said second capacitor is less than the capacitance of said first capacitor.

7. The battery pack as claimed in claim 1, wherein said first voltage threshold is less than a sum of cell voltages of said plurality of battery cells.

8. The battery pack as claimed in claim 1, further comprising:
a fuse coupled between said battery cells and a charger, wherein said fuse is burned out in response to said control signal.

9. An electronic system comprising:
a control circuit that receives a plurality of input voltages, and that determines that said input voltages are in a condition according to a comparison between each of said input voltages and a reference voltage, wherein said control circuit further comprises a control pin, and wherein said control circuit compares a voltage at said control pin with a first voltage threshold to select an operation mode from a normal mode and a test mode,
wherein in said normal mode, said control circuit compares said voltage at said pin with a second voltage threshold to generate an output signal, such that said output signal is generated if said input voltages remain in said condition for a time period that reaches a first time threshold,
wherein in said test mode, said control circuit generates said output signal if said input voltages remain in said condition for a time period that reaches a second time threshold.

10. The electronic system as claimed in claim 9, further comprising:
a signal generator, coupled to said control pin of said control circuit, that provides a test voltage greater than said first voltage threshold to said control pin so as to enable said control circuit to operate in said test mode.

11. The electronic system as claimed in claim 10, wherein said test voltage generated by said signal generator is no greater than a sum of said plurality of input voltages.

12. The electronic system as claimed in claim 9, further comprising:
a signal generator, coupled to said control circuit, that provides said plurality of input voltages to simulate cell voltages of a plurality of battery cells.

13. The electronic system as claimed in claim 9, further comprising:
a first capacitor coupled to said pin, wherein in said normal mode said control circuit provides a first current flowing through said first capacitor so as to provide said voltage at said control pin.

14. The electronic system as claimed in claim 13, wherein in said test mode said control circuit provides a second current that is greater than said first current flowing through said first capacitor so as to provide said voltage at said control pin, and wherein in said test mode said control circuit compares said voltage at said control pin with said second voltage threshold to generate said output voltage.

15. The electronic system as claimed in claim 13, wherein said control circuit further comprises:
a second capacitor having a capacitance less than that of said first capacitor, wherein in said test mode said control circuit provides said first current to flow through said second capacitor, and wherein in said test mode, said control circuit compares a voltage across said second capacitor with said second voltage threshold to generate said output voltage.

16. The electronic system as claimed in claim 9, wherein said first voltage threshold is less than a sum of said plurality of input voltages and greater than said second voltage threshold.

17. The electronic system as claimed in claim 9, further comprising:
a signal generator that generates a power voltage that is no greater than a sum of said input voltages to power said control circuit.

18. A method for controlling a plurality of battery cells, said method comprising:
determining a condition of said battery cells by a control circuit according to a plurality of cell voltages of said battery cells, wherein said control circuit comprises a pin;
comparing a voltage at said pin with a first voltage threshold to select an operation mode from a plurality of modes including a first mode and a second mode for said control circuit;
generating an output signal based on a comparison between said voltage at said pin and a second voltage threshold when said control circuit operates in said first mode, such that said output signal is generated if said battery cells remain in said condition for a time period that reaches a first time threshold; and
generating said output signal if said battery cells remain in said condition for a time period that reaches a second time threshold when said control circuit operates in said second mode.

19. The method as claimed in claim 18, further comprising:
generating a first current flowing through a capacitor coupled to said pin when said control circuit operates in said first mode;
generating a second current flowing through said capacitor when said control circuit operates in said second mode, wherein a level of said second current is greater than a level of said first current; and
comparing said voltage at said pin with said second voltage threshold to generate said output signal when said control circuit operates in said second mode.

20. The method as claimed in claim 18, further comprising:
conducting a current through a first capacitor coupled to said pin when said control circuit operates in said first mode;
conducting said current through a second capacitor when said control circuit operates in said second mode, wherein the capacitance of said second capacitor is less than the capacitance of said first capacitor; and
comparing a voltage at said second capacitor with said second voltage threshold to generate said output signal when said control circuit operates in said second mode.

21. The method as claimed in claim 18, further comprising:
providing a test voltage that is greater than said first voltage threshold to enable said control circuit to operate in said second mode.
